(19) United States
(12) Patent Application Publication
(10) Pub. No.: US 2021/0356819 A1
(43) Pub. Date: Nov. 18, 2021

(54) DISPLAY SUBSTRATE, DISPLAY PANEL AND DISPLAY APPARATUS

(71) Applicant: BOE TECHNOLOGY GROUP CO., LTD., Beijing (CN)

(72) Inventors: Detao Zhao, Beijing (CN); Li Xiao, Beijing (CN); Dongni Liu, Beijing (CN); Lei Wang, Beijing (CN); Liang Chen, Beijing (CN); Jifeng Tan, Beijing (CN); Minghua Xuan, Beijing (CN); Xiaochuan Chen, Beijing (CN)

(73) Assignee: BOE TECHNOLOGY GROUP CO., LTD., Beijing (CN)

(21) Appl. No.: 16/613,172

(22) PCT Filed: May 15, 2019
(86) PCT No.: PCT/CN2019/087039

§ 371 Date: Nov. 13, 2019

(30) Foreign Application Priority Data
Sep. 14, 2018 (CN) 201811075464.3

(51) Int. Cl. G02F 1/1343; G02F 1/1335

(52) U.S. Cl. CPC G02F 1/134363; G02F 1/133512; G02B 6/005; G02F 1/133524; G02F 1/133514

(57) ABSTRACT

Provided is a display substrate (100). The display substrate (100) may include a first base substrate (101). The first base substrate (101) may have a plurality of sub-pixel regions (102). Each of the plurality of sub-pixel regions (102) may include a light shielding region (103) and opening regions (104) respectively on both sides of the light shielding region (103). The display substrate (100) may further include a first transparent electrode (1) in each of the plurality of sub-pixel regions (102). The first transparent electrode (1) may include a first electrode unit (10) in the light shielding region (103), and the first electrode unit (10) may include a plurality of first strip electrodes (11) separated from one another. At least one of the plurality of first strip electrodes (11) forms an acute angle with a reference direction, the reference direction being a direction along which the light shielding region (103) and the opening regions (104) are arranged.

### CROSS-REFERENCE TO RELATED APPLICATIONS

This application claims benefit of the filing date of Chinese Patent Application No. 201811075464.3 filed on Sep. 14, 2018, the disclosure of which is hereby incorporated in its entirety by reference.

### TECHNICAL FIELD

This disclosure relates to the field of display technologies, and in particular, to a display substrate, a display panel, and a display apparatus.

### BACKGROUND

For a lateral electric field type of liquid crystal display apparatus, the light emitted by the backlight needs to pass through two polarizing plates. Accordingly, the transmittance is low and the power consumption is large. In order to solve the above technical problem, the prior art adopts a collimated light source display technology. The backlight in the collimated light source display technology adopts a collimated light source, and the collimated light emitted is projected to the display panel through a light extraction port. A light shielding pattern is provided on a color film substrate at a position corresponding to the light extraction port. When a driving electric field is not applied, the light is blocked by the light shielding pattern to realize a dark state display. When a driving electric field is applied, the liquid crystal molecules are deflected to form a liquid crystal prism, and the incident collimated light is deflected and emitted from the open regions on both sides of the light shielding pattern to realize a bright state display. Display of different gray scales are realized according to the degrees of light deflection. It can be seen that the collimated light source display technology does not require a polarizing plate to polarize light, and accordingly has a large transmittance and low power consumption.

### BRIEF SUMMARY

One embodiment of the present disclosure provides a display substrate. The display substrate may include a first base substrate. The first base substrate may have a plurality of sub-pixel regions. Each of the plurality of sub-pixel regions may include a light shielding region and opening regions respectively on both sides of the light shielding region. The display substrate may further include a first transparent electrode in each of the plurality of sub-pixel regions. The first transparent electrode may include a first electrode unit in the light shielding region, and the first electrode unit may include a plurality of first strip electrodes separated from one another. At least one of the plurality of first strip electrodes respectively form an acute angle with a reference direction, the reference direction being an direction along which the light shielding region and the opening regions are arranged.

Optionally, the plurality of first strip electrodes in the first electrode unit is parallel to one another.

Optionally, the first strip electrodes in the plurality of sub-pixel regions are parallel to one another.

Optionally, in each of the sub-pixel regions, the first transparent electrode further comprises a second electrode unit in each of the opening regions, the second electrode unit comprises a plurality of second strip electrodes, and the plurality of second strip electrodes are parallel to one another.

Optionally, the plurality of second strip electrodes is in parallel with the plurality of first strip electrodes.

Optionally, the plurality of second strip electrodes is not in parallel with the plurality of first strip electrodes.

Optionally, the plurality of sub-pixel regions are arranged in a plurality of rows and a plurality of columns, a first angle between the first strip electrodes in the sub-pixel regions of two adjacent rows is greater than 0°, and the first strip electrodes in the sub-pixel regions of the same row are arranged in parallel to one another.

Optionally, the light shielding region comprises a plurality of sub-regions, the first strip electrodes in a same sub-region of the plurality of sub-regions are in parallel to one another, and a second angle between the first strip electrodes in at least two of the plurality of sub-regions is greater than 0°.

Optionally, the plurality of sub-regions comprise a first sub-region and two second sub-regions respectively on both sides of the first sub-region, and a third angle between the first strip electrodes in the two second sub-regions is greater than 0°.

Optionally, the plurality of second strip electrodes in the opening regions is in parallel with the first strip electrodes in the adjacent second sub-regions.

Optionally, the plurality of sub-regions comprise a first sub-region and two second sub-regions respectively on both sides of the first sub-region, the first strip electrodes in the two second sub-regions are parallel to one another, and a fourth angle between the first strip electrodes in the first sub-region and those in the two second sub-regions is greater than 0°.

Optionally, the acute angle between the at least one of the first strip electrodes and the reference direction is in a range: 7°≤α≤30°.

Optionally, a separation distance between two adjacent first strip electrodes increases along a direction, which is parallel to a surface of the first base substrate, away from a center line of the light shielding regions.

Optionally, a light extraction structure is in the light shielding region on the first base substrate.

One embodiment of the present disclosure is a display panel, comprising an array substrate and a color film substrate opposite the array substrate. The array substrate is the display substrate according to one embodiment of the present disclosure.

Optionally, the color film substrate comprises a black matrix for defining a plurality of sub-pixel regions of the color film substrate and a light shielding pattern in a light shielding region of each of the plurality of sub-pixel regions.

Optionally, the light shielding pattern crosses through at least one of the sub-pixel regions of the color film substrate.

Optionally, the color film substrate further comprises a filter layer that transmits light of a specific color in each of opening regions of the sub-pixel regions.

Optionally, the filter layer that transmits light of a same color is respectively in the opening regions of the same column of the sub-pixel regions.

One embodiment of the present disclosure is a display apparatus, comprising the display panel according to one embodiment of the present disclosure, a collimated light source, a light guide plate, and a light extraction structure on a light emitting surface of the light guide plate. The light extraction structure is configured to take out light rays that are transmitted in the light guide plate and the light extraction structure has a one-to-one correspondence with each of the sub-pixel regions of the display substrate. Orthographic projection of the light extraction structure on the color film substrate falls within the light shielding pattern of each of the sub-pixel regions.

Optionally, the light guide plate is used as the first base substrate of the display substrate, and an orthographic projection of the light extraction structure on the color film substrate is within an orthographic projection of the light shielding pattern on the color film substrate.

### BRIEF DESCRIPTION OF THE DRAWINGS

In order to more clearly illustrate the embodiments of the present disclosure or the technical solutions in the prior art, the drawings used in the embodiments or the description of the prior art will be briefly described below. Obviously, the drawings in the following description are only embodiments of the present disclosure, and other drawings can be obtained from those skilled in the art without any inventive labor.

FIG. 1 is a partial schematic structural view of a display substrate of a display apparatus in the related art;

FIG. 2a is a partial schematic structural view of a display substrate of a display apparatus according to one embodiment of the present disclosure;

FIG. 2b is a schematic illustration of working principle of a display substrate of a display apparatus according to one embodiment of the present disclosure;

FIG. 3 is a cross-sectional view taken along line A-A of FIG. 1 in a bright state display;

FIG. 4 is a cross-sectional view taken along line A-A of FIG. 1 in a dark state display;

FIG. 5 is a schematic view of a partial structure of a display substrate of a display apparatus according to one embodiment of the present disclosure;

FIG. 6 is a schematic view of a partial structure of a display substrate of a display apparatus according to one embodiment of the present disclosure;

FIG. 7 is a schematic view of a partial structure of a display substrate of a display apparatus according to one embodiment of the present disclosure;

FIG. 8 is a schematic view of a partial structure of a display substrate of a display apparatus according to one embodiment of the present disclosure;

FIG. 9 is a schematic view of a partial structure of a display substrate of a display apparatus according to one embodiment of the present disclosure;

FIG. 10 is a schematic view of a partial structure of a display substrate of a display apparatus according to one embodiment of the present disclosure.

### DETAILED DESCRIPTION

Exemplary embodiments will now be described more fully with reference to the accompanying drawings. However, the exemplary embodiments can be embodied in a variety of forms and should not be construed as being limited to the embodiments set forth herein. On the contrary, those embodiments provided make the disclosure comprehensive and complete and convey all the ideas of the exemplary embodiments to those skilled in the art. The described features, structures, or characteristics may be combined in any suitable manner in one or more embodiments. In the following description, numerous specific details are set forth and provide the full understanding of the embodiments of the present disclosure. However, one skilled in the art will appreciate that the technical solution of the present disclosure may be practiced without one or more of the specific details, or may employ other methods, components, materials, apparatuses, steps, etc. In other instances, well-known technical solutions are not shown or described in detail to avoid obscuring aspects of the present disclosure.

In addition, the drawings are merely schematic illustrations of the present disclosure, and are not necessarily drawn to scale. The same reference numerals in the drawings denote the same or similar parts, and the repeated description thereof will be omitted.

The liquid crystal display apparatus having a collimated light source comprises a display panel and a collimated back light source, a light guide plate and light extraction structures. The display panel includes a plurality of sub-pixel regions, and the light extraction structures have a one-to-one correspondence with the positions of the sub-pixel regions. The collimated light emitted by the collimated light source is incident on the light guide plate and is transmitted in a total reflection manner in the light guide plate. The light extraction structure is disposed on a surface of the light guide plate, and the light transmitted by the total reflection in the light guide plate can be extracted out and projected to the corresponding sub-pixel region.

The display panel includes a color film substrate, an array substrate opposite the color film substrate, and liquid crystals filled between the color film substrate and the array substrate. Each sub-pixel region of the array substrate includes a pixel electrode and a common electrode. The pixel electrode and/or the common electrode are slit electrodes for forming a lateral driving electric field that drives deflection of the liquid crystal molecules. The color film substrate includes a black matrix for defining a plurality of sub-pixel regions. Each of the sub-pixel regions includes a light shielding region and an opening region respectively on both sides of the light shielding region. The light shielding region is provided with a light shielding pattern. Orthographic projection of the light extraction structure on the color film substrate falls within the light shielding pattern. When a driving electric field is not applied, the liquid crystal molecules are not deflected, and accordingly the collimated light rays taken out from the light extraction structure are blocked by the light-shielding pattern, thereby realizing a dark state display. When a driving electric field is applied, the liquid crystal molecules are deflected to form a liquid crystal prism. As such, the incident collimated light from the light extraction structure is deflected and emitted out from the open regions on both sides of the light shielding pattern, thereby realizing a bright state display. Display of different gray scales may be realized according to the degree of the light deflection.

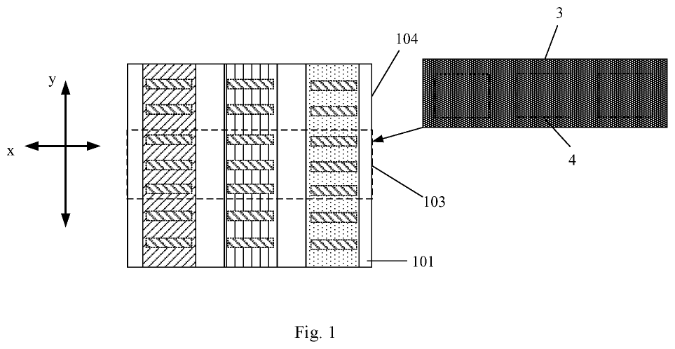

However, in the prior art, as shown in FIG. 1, each slit electrode comprises a plurality of strip electrodes. The strip electrodes of the slit electrodes in each sub-pixel region of the array substrate are parallel to the two sides of the sub-pixel region extending in the x direction. The transmission direction of the light after passing through the liquid crystal prism is perpendicular to the x direction. As a result, a normal display pattern can be viewed from both sides extending in the x direction. But there is a color shift problem when being viewed from both sides extending in the y direction.

In order to solve the above technical problem, for a liquid crystal display apparatus having a collimated light source, at least some of the strip electrodes of the slit electrodes of the array substrate according to some embodiments of the present disclosure are not parallel to the two sides of the sub-pixel region extending in the x direction. Therefore, the light after passing through the liquid crystal prism is transmitted obliquely. As such, the light has a light component in each of the directions along all sides of the sub-pixel region respectively, thereby solving the color shift problem when being viewed in other directions.

Specific embodiments of the present disclosure will be further described in detail below with reference to the drawings and embodiments. The following examples are intended to illustrate the disclosure but are not intended to limit the scope of the disclosure.

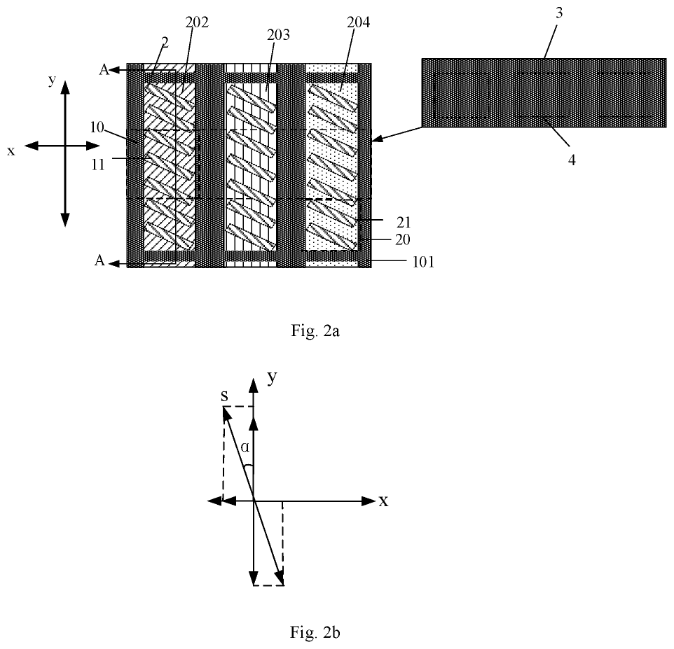

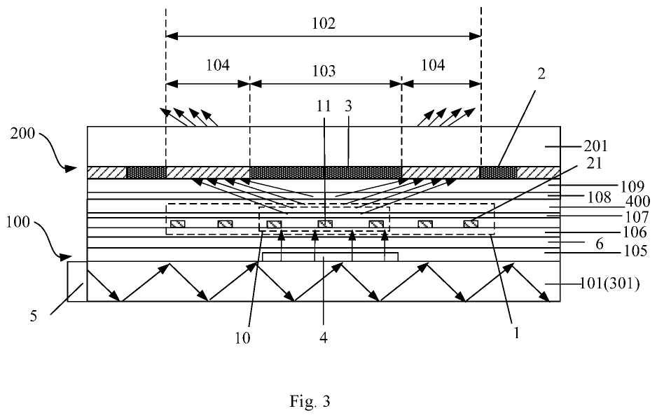

FIG. 2 shows a partial schematic structural view of a display substrate according to some embodiments of the present disclosure. This display substrate may be applied to a lateral electric field type of liquid crystal display apparatus using a collimated backlight source, that is, a liquid crystal display apparatus having a collimated light source. FIG. 3 is a cross-sectional view taken along line A-A of FIG. 2 in a bright state display. FIG. 3 is a cross-sectional view taken along line A-A of FIG. 2 in a dark state display. As shown in FIGS. 2-4, the display substrate 100 includes a first base substrate 101 having a plurality of sub-pixel regions 102. Each of the sub-pixel regions 102 includes a light shielding region 103 and an opening region 104 respectively on both sides of the light shielding region 103. A first transparent electrode 1 is disposed in each of the sub-pixel regions 102. The first transparent electrode 1 includes a first electrode unit 10 located in the light shielding region 103. The first electrode unit 10 includes a plurality of first strip electrodes 11 separated from one another. At least one of the plurality of first strip electrodes 11 does not form an angle of 90° with the reference direction, that is, the y direction indicated by the double arrow in FIG. 2. The reference direction is a direction along which the light shielding region 103 and the opening regions 104 are arranged. In one embodiment, at least one of the plurality of first strip electrodes form an acute angle with the reference direction.

In the embodiment of the present disclosure, the shape of the sub-pixel region 102 is generally a rectangle or a square. Two sides of the sub-pixel region of the display substrate are set to extend in the x direction, and the other two sides extend in the y direction. If the extending direction of the first strip electrodes 11 is parallel to the x direction, the direction in which the light transmits after passing through the liquid crystal prism is perpendicular to the x direction. As such, a normal pattern can be viewed from both sides extending in the x direction, while there is a color shift problem when being viewed from both sides extending in the y direction. Similarly, if the extending direction of the first strip electrodes 11 is parallel to the y direction, the direction in which the light transmits after passing through the liquid crystal prism is perpendicular to the y direction. As such, the normal pattern can be viewed from both sides extending in the y direction, while there is a color shift problem when being viewed in both directions extending in the x direction.

In the embodiments of the present disclosure, as shown in FIG. 2a and FIG. 2b, at least some of the first strip electrodes 11 do not form an angle of 90° with the direction along which the light shielding region 103 and the opening region 104 are arranged. That is, at least some of the first strip electrodes 11 are not parallel to the two sides of the sub-pixel region 102 extending in the x direction. Therefore, the liquid crystal molecules can align under the action of the electric field to form an inclined liquid crystal prism. The light after passing through the liquid crystal prism is transmitted in an oblique direction such as the S direction with reference to all the sides of the sub-pixel region, as shown in FIG. 2b, under scattering action of the inclined liquid crystal prism. As such, the light has a light component in each of the directions along all sides of the sub-pixel region, respectively, thereby solving the color shift problem when being viewed in other directions.

In some embodiments of the present disclosure, the acute angle between the extending direction of at least some of the first strip electrodes 11 and the reference direction is a, and the range of a can be set to: 7°≤α≤30° to ensure that the light has a light component in the directions of all sides of the sub-pixel region respectively. For example: a can be 7°, 15°, 20° or 30°.

The structure of the first electrode unit 10 will be described in detail below through a specific embodiment.

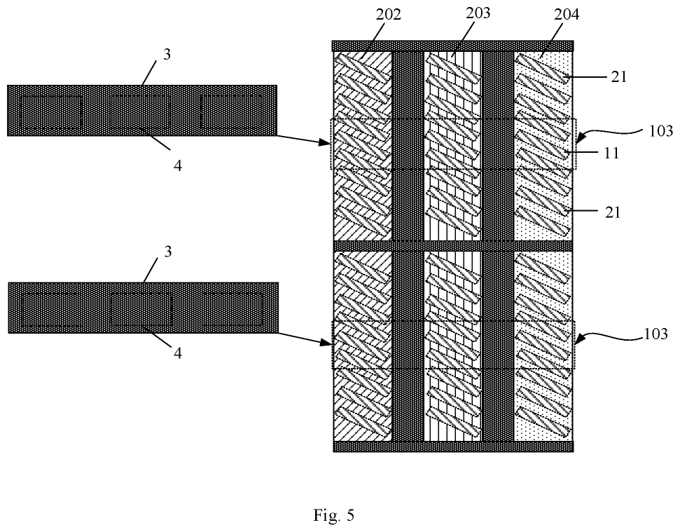

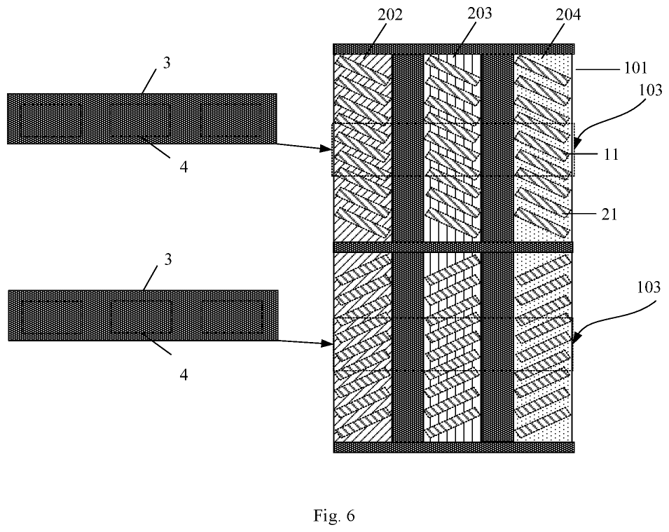

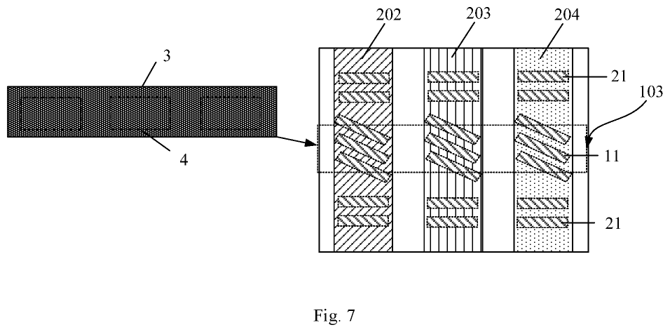

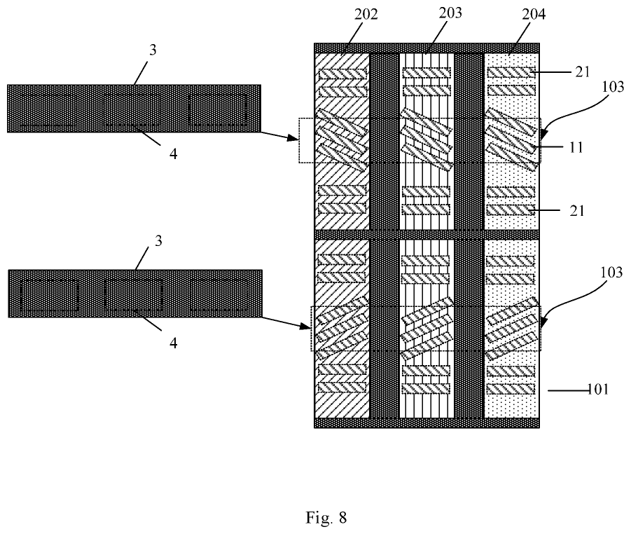

In some embodiments, referring to FIG. 2a, FIG. 5, FIG. 6, FIG. 7 and FIG. 8, all the first strip electrodes 11 of the first electrode unit 10 of the first transparent electrode 1 located in the light shielding region 103 are all arranged in parallel to one another, thereby simplifying the structure of the first transparent electrode and reducing the manufacturing cost.

In some embodiments, referring to FIG. 5, the first strip electrodes 11 of all the sub-pixel regions 102 may be disposed in parallel, thereby further simplifying structure of the first transparent electrode and reducing the manufacturing cost.

In some embodiments, the first angle between the first strip electrodes of different sub-pixel regions is set to be greater than 0°. For example, referring to FIG. 6 and FIG. 8, the first angle between the first strip electrodes 11 in two adjacent rows of the sub-pixel regions 102 is greater than 0°. The first strip electrodes 11 in the sub-pixel regions 102 located in the same row are disposed in parallel, thereby being capable of providing a dual domain display mode and increasing the viewing angle.

It should be noted that the structure for realizing the angle between the first strip electrodes of different sub-pixel regions greater than 0° is not limited to the above examples, and will not be enumerated here.

In some embodiments, as shown in FIG. 2, FIG. 5 and FIG. 6, for a sub-pixel region, the first transparent electrode 1 may further include a second electrode unit 20 located in the opening region 104. The second electrode unit 20 includes a plurality of second strip electrodes 21. For a sub-pixel region, the second strip electrodes 21 may be disposed in parallel with the first strip electrodes 11, thereby simplifying the structure of the first transparent electrode and reducing the manufacturing cost.

In some embodiments, as shown in FIG. 7 and FIG. 8, for one sub-pixel region 102, all the second strip electrodes 21 of the second electrode unit may be disposed in parallel to one another, and the angle between the second strip electrodes 21 and the first strip electrodes 11 is greater than 0°. In another embodiment, for a sub-pixel region, the plurality of second strip electrodes of the second electrode unit may be disposed not completely in parallel to one another, which is not limited herein.

In the above embodiments, the first strip electrodes 11 of the first electrode unit 10 of the first transparent electrode 1 located in the light shielding region 103 are obliquely disposed with respect to the reference direction, and all of the first strip electrodes 11 are disposed in parallel to one another.

In some embodiments, the plurality of first strip electrodes 11 of the first electrode unit 10 may not be completely parallel to one another, and the following description will be made in a specific embodiment.

In some embodiments, the first electrode unit of the first transparent electrode located in the light shielding region includes a plurality of sub-regions. The first strip electrodes in the same sub-region are disposed in parallel to one another. A second angle between the first strip electrodes in at least two of the sub-regions is greater than 0°, thereby enabling multi-domain display to increase viewing angle.

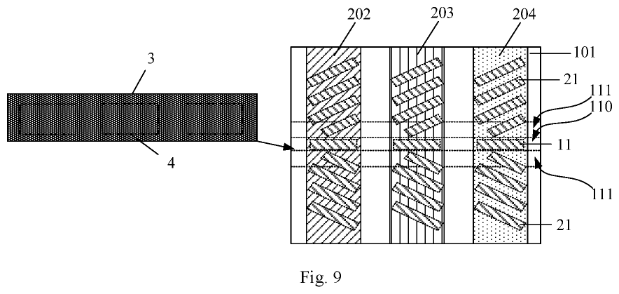

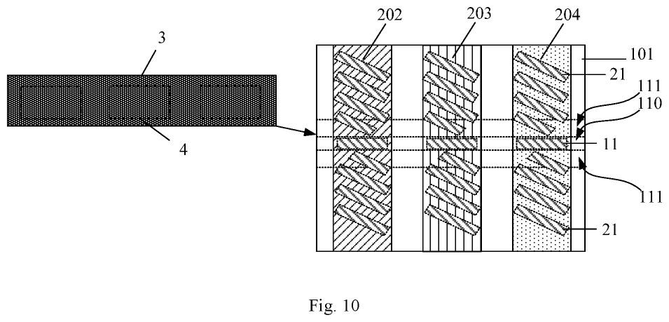

In some embodiments, referring to FIG. 9 and FIG. 10, the first electrode unit 10 may be divided into three sub-regions. The three sub-regions include a first sub-region 110 and two second sub-regions 111. The two second sub-regions 111 are respectively located on opposite sides of the first sub-region 110. The third angle between the first strip electrodes 11 in the two second sub-regions 111 is greater than 0°.

In some embodiments, the first strip electrodes 11 in the two second sub-regions 111 may be inclined with respect to the reference direction. That is, the extending direction of the first strip electrodes 11 in the two second sub-regions 111 is neither parallel to the sides of the sub-pixel region extending in the x direction nor parallel to the sides of the sub-pixel region extending in the y direction. The first strip electrodes 11 in the first sub-region 110 may also be disposed not obliquely, that is, the extending direction of the first strip electrodes 11 in the first sub-region 110 is parallel to the side extending in the x direction, or is parallel to the side extending in the y direction. The extending direction of the first strip electrodes 11 in the first sub-region 110 illustrated in FIGS. 9 and 10 is parallel to the side extending in the x direction. For a sub-pixel region 102, the first strip electrodes 11 in the two second sub-regions 111 may be arranged in parallel (as shown in FIG. 10) or may not be arranged in parallel (as shown in FIG. 9). These are merely examples, which are not limited thereto in the embodiments of the present disclosure.

In some embodiments of the present disclosure, the display substrate includes a plurality of rows of sub-pixel regions. For all the sub-pixel regions 102 of the same row, the first strip electrodes 11 in the second sub-region 111 on the same side are arranged in parallel, thereby simplifying the structure thereof.

In one embodiment, a separation distance between two adjacent first strip electrodes increases along a direction, which is parallel to a surface of the first base substrate, away from a center line of the light shielding regions.

In some embodiments, as shown in FIG. 2, FIG. 9 and FIG. 10, the first transparent electrode 1 further includes a second electrode unit 20 located in the opening region 104, and the second electrode unit 20 includes a plurality of second strip electrodes 21 disposed in parallel. Wherein, the second strip electrodes 21 in the opening region 104 are disposed in parallel with the first strip electrodes in the adjacent second sub-region 111, thereby simplifying the structure thereof. Further, for all the sub-pixel regions 102 of the same row, the first strip electrodes 11 in the second sub-regions 111 on the same side may be disposed in parallel. Wherein, for all the sub-pixel regions 102 of the same row, the first strip electrodes 11 located in the second sub-regions 111 on different sides of the first sub-region 110 may be arranged in parallel (as shown in FIG. 10), or may not be arranged in parallel (as shown in FIG. 9).

In the above embodiments, two specific implementation structures of the first transparent electrode of the present disclosure are given. Obviously, the specific implementation structure of the first transparent electrode of the present disclosure is not limited to the above two modes. In those embodiments, at least some of the first strip electrodes of the first electrode unit of the first transparent electrode located in the light-shielding region are disposed obliquely with respect to the reference direction, and will not be enumerated here.

In some embodiments, referring to FIG. 3, the display substrate further includes a second transparent electrode 6 disposed on the first base substrate 101. In one embodiment of the present disclosure, the first transparent electrode 1 is a common electrode, the second transparent electrode 6 is a pixel electrode, and the common electrode is located on a side of the pixel electrode opposite from the first base substrate 101. Of course, in some other embodiments of the present disclosure, the first transparent electrode 1 is a pixel electrode, and the second transparent electrode 6 is a common electrode. The second transparent electrode may also be a slit electrode, and have a similar structure as the first transparent electrode of the present disclosure. The material of the common electrode and the pixel electrode may be indium tin oxide (ITO).

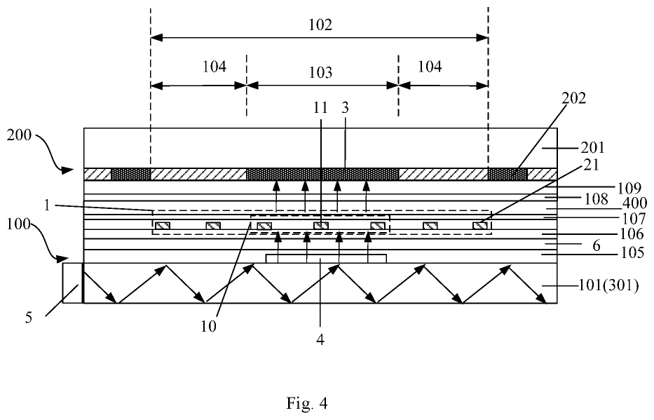

As shown in FIG. 2, FIG. 3 and FIG. 4, a display panel is further provided in some embodiments of the present disclosure, which comprises an array substrate and a color film substrate 200 forming a cell and the liquid crystals 400 filled between the display substrate 100 and the color film substrate 200. The array substrate adopts the display substrate 100 as described above, and can solve the color shift problem and improve the display quality.

Since the sub-pixel region of the display substrate and the sub-pixel region of the color film substrate are in one-to-one correspondence, the display light of each sub-pixel region of the display substrate is transmitted to the display side through the corresponding sub-pixel region of the color film substrate. Therefore, in the following, for convenience of description and understanding, the sub-pixel region of the display substrate and the sub-pixel region of the color film substrate are denoted by a same reference numeral.

In some embodiments, the color film substrate 200 includes a second substrate 201 and a black matrix 2 disposed on the second substrate 201. The black matrix 2 is used to define the plurality of sub-pixel regions 102. Each sub-pixel region 102 of the color film substrate includes a light-shielding region 103 and an opening region 104 respectively on both sides of the light-shielding region 103. A light-shielding pattern 3 is disposed in the light-shielding region 103. Wherein, the light-shielding pattern 3 can be disposed in the same layer and made of the same opaque film as the black matrix 2, thereby simplifying the manufacturing process.

In some embodiments of the present disclosure, the color film substrate 200 may further include: a filter layer transmitting light of a specific color in each of the opening regions 104.

In some embodiments, the filter layer includes a red filter layer 202, a green filter layer 203, and a blue filter layer 204. Accordingly, the color display is realized by using three primary colors of red, green and blue. Here, it is merely exemplified and that the color combination of the filter layers for realizing color display is not limited to the three primary colors.

In some embodiments, the sub-pixel regions 102 of the color film substrate 200 are distributed in a matrix including a plurality of rows and columns of sub-pixel regions 102. The sub-pixel regions 102 of the same column are provided with a filter layer that transmits light of the same color (eg, a red filter layer 202, a green filter layer 203 or a blue filter layer 204).

A display apparatus is also provided in some embodiments of the present disclosure, and the display apparatus is a lateral electric field type of liquid crystal display apparatus using a collimated light source.

In some embodiments, referring to FIG. 3 and FIG. 4, the display apparatus includes a display panel, a collimated light source 5, a light guide plate 301, and a light extraction structure 4. The light guide plate 301 includes a light incident surface and a light exiting surface. A light emitting surface of the light source 5 is opposite a light incident surface of the light guide plate 301. The light guide plate 301 is configured to transmit light being incident into the light guide plate 301 through the light incident surface in a total reflection mode. The light extraction structure 4 is disposed on a light-emitting surface of the light guide plate 301, and is configured to take out light rays that are transmitted in a total reflection mode in the light guide plate 301. The display panel is the display panel according to some of the above embodiments. The light extraction structures 4 are in one-to-one correspondence with the positions of the sub-pixel regions 102 of the display substrate, and orthographic projection of the light extraction structure 4 on the display substrate is located within the light-shielding region 103 of the sub-pixel region 102. In one embodiment, the light extraction structure is disposed in the light shielding region on the first base substrate.

In some embodiments, as shown in FIG. 4, when a driving electric field is not applied, the liquid crystal molecules are not deflected. As such, the collimated light rays taken out from the light extraction structures 4 are blocked by the light shielding patterns 3, thereby realizing dark state display. As shown in FIG. 3, when a driving electric field is applied, the liquid crystal molecules are deflected to form a liquid crystal prism. As such, the incident collimated light is deflected and emitted from the opening regions 104 on both sides of the light shielding pattern 3, thereby realizing bright state display. Furthermore, different gray levels are displayed according to the degree of light deflection. In one embodiment, the light shielding pattern crosses through at least one of the sub-pixel regions of the color film substrate.

In order to ensure the display quality of the dark state, the contour of the orthographic projection of the light-extraction structure 4 on the plane of the color film substrate has a certain distance from the contour of the light-shielding pattern 3. As such, when the driving electric field is not applied, it is ensured that the collimated light transmitted from the light-extraction structure 4 is completely blocked by the light-shielding pattern 3, thereby realizing dark state display.

In some embodiments of the present disclosure, the display apparatus may further include a first planarization layer 105 covering the light extraction structure 4 for providing a flat surface.

In some embodiments of the present disclosure, the light extraction structure 4 may be a light extraction grating, or may be other types of light extraction structures.

In some embodiment of the present disclosure, the light guide plate 301 is commonly used as the first substrate 101 of the display substrate to reduce the thickness of the display apparatus. Of course, in other embodiments of the present disclosure, the light guide plate 301 may not be commonly used as the first substrate 101.

In some embodiments, as shown in FIG. 2, FIG. 3 and FIG. 4, the liquid crystal display apparatus having a collimated light source according to some embodiments specifically includes:

a display substrate 100 and a color film substrate 200 disposed to be assembled into a box, and a liquid crystal layer 400 filled between the display substrate 100 and the color film substrate 200; and

a collimated light source 5 for providing collimated light required for display.

Wherein the display substrate 100 includes:

a first base substrate 101, which is commonly used as a light guide plate, wherein a light source 5 is disposed adjacent to a side surface of the first base substrate 101, and the light emitted from the light source is incident on the first base substrate 101 through its side surface, and is transmitted in a total reflection mode through the first base substrate 101;

a light extraction structure 4 disposed on a surface of the first substrate 101 for extracting light from a surface of the first substrate 101; and

a first planarization layer 105 covering the light extraction structure 4.

The display substrate 100 includes a plurality of sub-pixel regions 102, each of which comprises a light-shielding region 103 and an opening region 104 respectively on both sides of the light-shielding region. Each of the sub-pixel regions 102 includes:

a pixel electrode 6 disposed on the planarization layer 105;

a semiconductor driving apparatus (not shown) disposed on the planarization layer 105 such as a thin film transistor for transmitting a pixel voltage to the pixel electrode 6;

a passivation layer 106 covering the semiconductor driving apparatus and the pixel electrode 6;

a first transparent electrode 1 disposed on the passivation layer 106; and

a first alignment film 107 covering the first transparent electrode.

The first transparent electrode 1 may be a common electrode, wherein the first transparent electrode 1 includes a first electrode unit 10 located in the light-shielding region 103, the first electrode unit 10 includes a plurality of first strip electrodes 11 disposed in parallel to one another, and the first strip electrodes 11 are disposed obliquely with respect to a reference direction. The first transparent electrode 1 further includes a second electrode unit 20 located in the opening region 104, the second electrode unit 20 includes a plurality of second strip electrodes 21 disposed in parallel to one another, and the first strip electrodes 11 and the second strip electrodes 21 in the same sub-pixel region 102 are arranged in parallel.

Wherein the color film substrate 200 includes:

a second substrate 201; and

a black matrix 2 disposed on the second substrate 201 for defining a plurality of sub-pixel regions 102, wherein each of the sub-pixel regions 102 includes a light-shielding region 103 and an opening region 104 respectively on both sides of the light-shielding region.

Each sub-pixel region 102 of the color film substrate 200 includes:

a light shielding pattern 3, which is disposed in the light shielding region 103 and has the same layer structure as the black matrix 2;

a filter layer, which is disposed in the opening region 104, wherein the filter layers of the same column of sub-pixel regions 102 transmit light of the same color;

a second planarization layer 109 covering the filter layer, the black matrix 2 and the light shielding pattern 3; and

a second alignment film 108 disposed on the second planarization layer 109.

Other embodiments of the present disclosure will be apparent to the skilled in the art from consideration of the specification and the disclosure herein. The present application is intended to cover any variations, uses, or adaptations of the present disclosure, which are in accordance with the general principles of the disclosure and include common general knowledge or common technical means in the art that are not disclosed in the present disclosure. The specification and examples of the present disclosure are to be regarded as illustrative only, and the scope and spirit of the disclosure is pointed out by the appended claims.

1. A display substrate, comprising:
a first base substrate, the first base substrate having a plurality of sub-pixel regions, each of the plurality of sub-pixel regions comprising a light shielding region and opening regions respectively on both sides of the light shielding region; and
a first transparent electrode in each of the plurality of sub-pixel regions, the first transparent electrode comprising a first electrode unit in the light shielding region, and the first electrode unit comprising a plurality of first strip electrodes separated from one another,
wherein at least one of the plurality of first strip electrodes forms an acute angle with a reference direction, the reference direction being an direction along which the light shielding region and the opening regions are arranged.

2. The display substrate according to claim 1, wherein the plurality of first strip electrodes in the first electrode unit are parallel to one another.

3. The display substrate according to claim 2, wherein the first strip electrodes in the plurality of sub-pixel regions are parallel to one another.

4. The display substrate according to claim 2, wherein in each of the sub-pixel regions, the first transparent electrode further comprises a second electrode unit in each of the opening regions, the second electrode unit comprises a plurality of second strip electrodes, and the plurality of second strip electrodes are parallel to one another.

5. The display substrate according to claim 4, wherein the plurality of second strip electrodes are in parallel with the plurality of first strip electrodes.

6. The display substrate according to claim 4, wherein the plurality of second strip electrodes are not in parallel with the plurality of first strip electrodes.

7. The display substrate according to claim 4, wherein the plurality of sub-pixel regions are arranged in a plurality of rows and a plurality of columns, a first angle between the first strip electrodes in the sub-pixel regions of two adjacent rows is greater than 0°, and the first strip electrodes in the sub-pixel regions of the same row are arranged in parallel to one another.

8. The display substrate according to claim 1, wherein the light shielding region comprises a plurality of sub-regions, the first strip electrodes in a same sub-region of the plurality of sub-regions are in parallel to one another, and a second angle between the first strip electrodes in at least two of the plurality of sub-regions is greater than 0°.

9. The display substrate according to claim 8, wherein the plurality of sub-regions comprise a first sub-region and two second sub-regions respectively on both sides of the first sub-region, and a third angle between the first strip electrodes in the two second sub-regions is greater than 0°.

10. The display substrate according to claim 9, wherein the plurality of second strip electrodes in the opening regions is in parallel with the first strip electrodes in the adjacent second sub-regions.

11. The display substrate according to claim 8, wherein the plurality of sub-regions comprise a first sub-region and two second sub-regions respectively on both sides of the first sub-region, the first strip electrodes in the two second sub-regions are parallel to one another, and a fourth angle between the first strip electrodes in the first sub-region and those in the two second sub-regions is greater than 0°.

12. The display substrate according to claim 1, wherein the acute angle between the at least one of the first strip electrodes and the reference direction is in a range: 7°≤α≤30°.

13. The display substrate according to claim 2, wherein a separation distance between two adjacent first strip electrodes increases along a direction, which is parallel to a surface of the first base substrate, away from a center line of the light shielding regions.

14. The display substrate according to claim 1, wherein a light extraction structure is in the light shielding region on the first base substrate.

15. A display panel, comprising an array substrate and a color film substrate opposite the array substrate, wherein the array substrate is the display substrate according to claim 1.

16. The display panel according to claim 15, wherein the color film substrate comprises a black matrix for defining a plurality of sub-pixel regions of the color film substrate and a light shielding pattern in a light shielding region of each of the plurality of sub-pixel regions.

17. The display panel according to claim 16, wherein the light shielding pattern crosses through at least one of the sub-pixel regions of the color film substrate.

18. The display panel according to claim 15, wherein the color film substrate further comprises a filter layer that transmits light of a specific color in each of opening regions of the sub-pixel regions.

19. The display panel according to claim 18, wherein the filter layer that transmits light of a same color is respectively in the opening regions of the same column of the sub-pixel regions.

20. A display apparatus, comprising the display panel according to claim 15,
a collimated light source,
a light guide plate, and
a light extraction structure on a light emitting surface of the light guide plate,
wherein the light extraction structure is configured to take out light rays that are transmitted in the light guide plate and the light extraction structure has a one-to-one correspondence with each of the sub-pixel regions of the display substrate, and orthographic projection of the light extraction structure on the color film substrate falls within the light shielding pattern of each of the sub-pixel regions,
the light guide plate is used as the first base substrate of the display substrate, and
an orthographic projection of the light extraction structure on the color film substrate is within an orthographic projection of the light shielding pattern on the color film substrate.

21. (canceled)
